(19) United States
(12) Patent Application Publication
(10) Pub. No.: US 2015/0332369 A1
(43) Pub. Date: Nov. 19, 2015

(54) CONTENT PROVIDING SYSTEM, SERVER, AND PROGRAM

(71) Applicant: TOSHIBA TEC KABUSHIKI KAISHA, Tokyo (JP)

(72) Inventor: Rintaro Nakane, Yokohama (JP)

(21) Appl. No.: 14/697,946

(22) Filed: Apr. 28, 2015

(30) Foreign Application Priority Data
May 19, 2014 (JP) 2014-103744

(51) Int. Cl. G06Q 30/06; H04L 29/08

(52) U.S. Cl. CPC G06Q 30/0623; H04L 67/104

(57) ABSTRACT

In a content providing system, a first electronic apparatus that is used by a customer, and a second electronic apparatus that is used by a store staff are connected to a server that provides a plurality of pieces of product-related information. The server includes a product extraction unit that extracts a specific product, whose information is provided to the customer, among the plurality of products on the basis of customer information that is registered with respect to the customer, first information that is input from the first electronic apparatus, and second information that is input from the second electronic apparatus, and a distribution unit that distributes a first content relating to the specific product to the first electronic apparatus, and distributes a second content different from the first content relating to the specific product to the second electronic apparatus.

### CROSS-REFERENCE TO RELATED APPLICATION

This application is based upon and claims the benefit of priority from Japanese Patent Application No. 2014-103744, filed May 19, 2014, the entire contents of which are incorporated herein by reference.

### FIELD

An embodiment described herein relates generally to a content providing system that provides content relating to a product and the like, a server, and a program.

### BACKGROUND

A business negotiation room for the exclusive use of members and the like is provided in large stores and the like. When desiring to use the business negotiation room for the exclusive use of members, a member can enter the room after acquisition of certification with a membership card and the like. In the business negotiation room, the member may receive a service such as provision of a beverage and introduction of a product by using a printed catalog from an out-of-store sales staff or a customer serving staff on a store side, and the like.

When using the printed catalog employing a paper medium, the higher the number of products that are published is, the more difficult it is for the member to find a product meeting their preference. In addition, when a customer designates a product from the printed catalog, it is necessary for a store staff to carry out an input operation to a dedicated terminal that is provided separately so as to carry out a procedure for reservation or purchase of the product and the like.

In addition, information published in the printed catalog may be simply electronized, and may be provided to a customer through an electronic apparatus. However, in this case, even though operability becomes satisfactory, it is difficult for the member to find a product that meets their preference.

In the related art, there is suggested a system in which information such as purchase history is analyzed for a number of customers, a product in accordance with a customer type is specified, and the product is recommended to the customers. JP-A-2013-239160 is an example of the related art.

### DESCRIPTION OF THE DRAWINGS

FIG. 1 is a block diagram illustrating a configuration example in which a content providing system of this embodiment is implemented as a customer service system.

FIG. 2 is a diagram illustrating an example of a situation in which the customer service system in this embodiment is used.

FIG. 3 is a block diagram illustrating an example of a configuration of a customer information management system in this embodiment;

FIG. 4 is a block diagram illustrating an example of a configuration of a content distribution system in this embodiment.

FIG. 5 is a diagram illustrating an example of customer information that is included in a customer information database of the customer information management system in this embodiment.

FIG. 6 is a diagram illustrating an example of information that is included in a product information database of the content distribution system in this embodiment.

FIG. 7 is a diagram illustrating an example of information that is included in an attribute cluster database of the content distribution system in this embodiment.

FIG. 8 is a diagram illustrating an example of product information for each attribute which is included in the attribute cluster database of the content distribution system in this embodiment.

FIG. 9 is a diagram illustrating flow of information that is transmitted and received between a store staff and a customer in the customer service system in this embodiment.

FIG. 10 is a flowchart illustrating a process of allocating a customer serving device to a customer who visits a business negotiation room in this embodiment.

FIG. 11 is a flowchart illustrating a process of synchronizing a tablet terminal and content that is displayed on a handy terminal in this embodiment.

FIG. 12 is a diagram illustrating extraction of content for a customer by the content distribution system in this embodiment.

FIG. 13 is a diagram illustrating a display example of content that is displayed on the tablet terminal in this embodiment.

FIG. 14 is a diagram illustrating a display example of content that is displayed on the tablet terminal in this embodiment.

FIG. 15 is a diagram illustrating an example of displaying content, which is synchronized with the tablet terminal, on a staff terminal in this embodiment.

FIG. 16 is a diagram illustrating a display example of content that is displayed on the tablet terminal in this embodiment.

FIG. 17 is a diagram illustrating a display example of content that is displayed on the tablet terminal in this embodiment.

FIG. 18 is a diagram illustrating a process of changing content on the basis of information that is input from the staff terminal in this embodiment.

FIG. 19 is a diagram illustrating extraction of content for a customer by the content distribution system in this embodiment.

FIG. 20 is a diagram illustrating a process of changing content on the basis of information that is input from the tablet terminal in this embodiment.

FIG. 21 is a diagram illustrating extraction of content for a customer by the content distribution system in this embodiment.

### DETAILED DESCRIPTION

As described above, in the related art, information such as purchase history is analyzed for a number of customers, and a product in accordance with a customer type can be specified. In this case, a member can find a product that meets their preference from a number of products in an easy manner in comparison to a case of using the printed catalog.

However, in the system of specifying a product in accordance with the customer type, it is difficult to introduce various pieces of information which are obtained by the store staff from the customer through communication between the store staff and the customer during customer service, or a demand of the customer at any point in time of a customer's request, and thus it is difficult to provide information of an appropriate customer's favorite products.

An object of an exemplary embodiment is to provide a content providing system, a server, and a program which are capable of appropriately providing information relating to customer's favorite products.

According to an embodiment, there is provided a content providing system in which a first electronic apparatus that is used by a customer, and a second electronic apparatus that is used by a store staff are connected to a server that provides a plurality of pieces of product-related information. The server includes a product extraction unit that extracts a specific product, whose information is provided to the customer, among the plurality of products on the basis of customer information that is registered with respect to the customer, first information that is input from the first electronic apparatus, and second information that is input from the second electronic apparatus, and a distribution unit that distributes a first content relating to the specific product to the first electronic apparatus, and distributes a second content different from the first content relating to the specific product to the second electronic apparatus.

Hereinafter, an embodiment will be described with reference to the accompanying drawings.

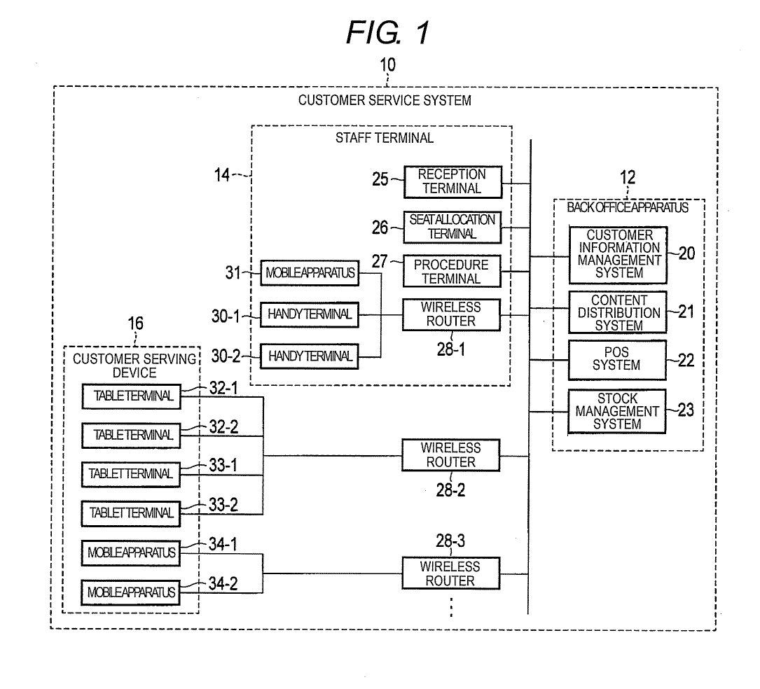

FIG. 1 is a block diagram illustrating a configuration example in which a content providing system of this embodiment is implemented as a customer service system 10. For example, the customer service system 10 can provide information (content) relating to products which are on sale in a shop to an electronic apparatus which is used by a customer or a store staff. For example, the customer service system 10 is provided in a business negotiation room for a customer in a store, and is used when a store staff serves the customer.

The customer service system 10 includes a back office apparatus 12 for management or control of a system, a staff terminal 14 that is used by the store staff, and a customer serving device 16 that is mainly used by the customer. For example, the back office apparatus 12 includes a customer information management system 20, a content distribution system 21, a point of sales (POS) system 22, and a stock management system 23.

For example, the staff terminal 14 includes a reception terminal 25, a seat allocation terminal 26, and a procedure terminal 27. For example, the customer information management system 20, the content distribution system 21, the point of sales (POS) system 22, the stock management system 23, the reception terminal 25, the seat allocation terminal 26, and the procedure terminal 27 are connected through a network such as a wired local area network (LAN), and can transmit and receive data to and from each other. In addition, the staff terminal 14 includes, for example, a plurality of handy terminals 30 (30-1, 30-2, . . . ), and a mobile apparatus 31 which are connected by a network such as a wireless LAN through a wireless router 28-1.

For example, the customer serving device 16 includes a plurality of table terminals 32 (32-1, 32-2, . . . ), a plurality of tablet terminals 33 (33-1, 33-2, . . . ), and a plurality of mobile apparatuses 34 (34-1, 34-2, . . . ) which are connected by a network such as a wireless LAN through a wireless router 28-2 or 28-3. In addition, an installation location of each of the table terminals 32 is fixed, and thus the table terminals 32 may be connected by a wired LAN. In addition, the customer service system 10 handles private information of a customer, and it is desirable to employ a closed LAN of which access from the outside of the system is denied from the viewpoint of security.

The customer information management system 20 manages various pieces of information relating to a customer who is registered as a member. For example, the customer information management system 20 manages a product purchase history, a customer's store visiting history, attendant information, and the like in addition to customer information relating to a customer who is registered during member registration. In addition, for example, the customer information management system 20 has a function of managing information (recommendation information) for a specific product which is distributed to a customer from the content distribution system 21, and a browsing history for the recommendation information. In addition, the customer information management system 20 has a function of distributing information to the staff terminal 14, receiving information from the staff terminal 14, and transmitting and receiving information to and from the other systems 21 to 23.

The content distribution system 21 manages information (recommendation information) relating to a product which is to be distributed to the staff terminal 14 or the customer serving device 16. The content distribution system 21 has a function of extracting a product to be recommended to a customer on the basis of the customer information that is managed by the customer information management system 20, information that is input from the staff terminal 14 or the customer serving device 16, and the like, and of distributing recommendation information (content) relating to the product to the staff terminal 14 or the customer serving device 16. For example, the content distribution system 21 combines plural pieces of information in which customer attributes or product attributes are clustered, and extracts a product (product cluster) which is recommended to a customer through cluster analysis. For example, the content distribution system 21 has a designated customer attribute extraction function of extracting a customer attribute on the basis of customer information, a cluster management function of managing a customer attribute cluster and a product attribute cluster, a function of managing product information, a recommendation information inference function of extracting a product (product cluster) to be recommended to a customer, a supplementary information extraction function of extracting supplementary information to be distributed to the staff terminal 14, and the like. In addition, the content distribution system 21 is provided with a function of distributing information to the staff terminal 14, a function of receiving information from the staff terminal 14, a function of distributing information to the customer serving device 16, a function of receiving information from the customer serving device 16, and a function of transmitting and receiving information to and from the other systems 20, 22, and 23.

The POS system 22 manages sales of products in a shop. The POS system 22 has a payment processing function, a function of managing a purchase history, and a function of transmitting and receiving information to and from the customer information management system 20 or the stock management system 23. The stock management system 23 has a function of managing a product stock in a shop, a function of transmitting and receiving information to and from the customer information management system 20 or the POS system 22, and the like on the basis of sales of products which are managed by the POS system 22.

For example, the systems 20 to 23 can be realized by a single server (computer), or by combining a plurality of servers or other electronic apparatuses. In addition, arbitrary systems of the systems 20 to 23 may be combined to be realized as one system.

For example, the reception terminal 25 is realized by a personal computer. The reception terminal 25 includes a CPU, a network interface controller, a storage (a memory, a solid state drive (SSD), an HD, or the like), an input device, a display device, and the like, and operates on the basis of a program such as an operating system (OS), middleware, and various applications. The reception terminal 25 executes a reception task application program by the CPU to realize a function for the reception task. For example, the reception terminal 25 has an authentication information input function of inputting authentication information that is inherent to a customer, a customer information reference function of making an inquiry to the customer information management system 20 on the basis of authentication information, an additional information input function of inputting information (a store visiting purpose, the number of accompanying persons, an attribute, and the like) which relates to a customer and is input by the store staff (reception attendant), a function of transmitting and receiving information to and from the customer information management system 20 or the staff terminal 14, and the like. Examples of the authentication information that is input by the reception terminal 25 include a member ID that is recorded in a membership card of a customer, information that is extracted from an image obtained by capturing a face of the customer, and the like, biometrics information (a fingerprint, a voiceprint, an iris, a vein pattern, and the like) of a customer, a personal identification number, a password, and the like.

For example, the seat allocation terminal 26 is realized by a personal computer. The seat allocation terminal 26 includes a CPU, a network interface controller, a storage (a memory, an SSD, an HD, or the like), an input device, a display device, and the like, and operates on the basis of a program such as an OS, middleware, and various applications. The seat allocation terminal 26 executes a seat allocation task application by the CPU to realize a function for the seat allocation task. For example, the seat allocation terminal 26 has a function of allocating each of the tablet terminals 33 and the table terminals 32 to a customer, a function of transmitting and receiving information to and from the customer information management system 20 or the staff terminal 14, and the like.

For example, the procedure terminal 27 is realized by a personal computer. The procedure terminal 27 includes a CPU, a network interface controller, a storage (a memory, an SSD, an HD, or the like), an input device, a display device, and the like, and operates on the basis of a program such as an OS, middleware, and various applications. The procedure terminal 27 executes various function providing applications by the CPU to realize a function for reservation or purchase of a product. For example, the procedure terminal 27 has a function of transmitting and receiving information to and from the table terminals 32 or the tablet terminals 33, a function of transmitting and receiving information to and from the content distribution system 21, a function of searching product information, a product reservation and purchase procedure function, a function of transmitting and receiving information to and from the customer information management system 20, a function of transmitting and receiving information to and from other apparatuses including the POS system 22 and the stock management system 23, and the like. In addition, the procedure terminal 27 has a print function of printing a receipt when a printer is connected thereto, and a scanner function of reading out an image of a document and the like when a scanner is connected thereto.

For example, each of the handy terminals 30 has the same function as that of a personal computer. The handy terminal 30 includes a CPU, a wireless network interface controller, a near-field wireless communication unit, a storage (a memory, an SSD, an HD, or the like), an input device (including a touch panel), a display device, and the like, and operates on the basis of a program such as an OS, middleware, and various applications. In addition, the handy terminal 30 includes a card reader, a barcode reader, a camera, and the like. The handy terminal 30 operates on the basis of a program such as an OS, middleware, and various applications. The handy terminal 30 executes various function providing applications by the CPU to realize a function for business negotiation with a customer, and the like. For example, the handy terminal 30 has a function of transmitting and receiving information to and from the table terminal 32 or the tablet terminal 33 through near-field wireless communication, a function of transmitting and receiving information to and from the content distribution system 21, a function of searching product information, a function of transmitting and receiving information to and from other apparatuses including the customer information management system 20, the POS system 22, and the stock management system 23. In addition, the handy terminal 30 has a function of transmitting and receiving information to and from another staff terminal 14 through near-field wireless communication or a network. The handy terminal 30 determines identification information that is inherent to a customer (or the table terminal 32 and the tablet terminal 33 which are used by the customer) through a recognition process with respect to data that is read out from a membership card by the card reader, a one-dimensional or two-dimensional barcode that is read out by the barcode reader, or a two-dimensional barcode or an image that is captured by the camera. The handy terminal can display information, which is synchronized with recommendation information (content) that is displayed on the table terminal 32 or the tablet terminal 33 which is used by a customer, through the customer information management system 20 and the content distribution system 21 on the basis of the identification information.

For example, the mobile apparatus 31 is realized by a tablet type personal computer, a smart phone, and the like. The mobile apparatus 31 can realize the same function as that of the handy terminal 30 by executing an application that allows the mobile apparatus 31 to function as the staff terminal 14.

For example, the table terminal 32 has approximately the same configuration as that of a personal computer. The table terminal 32 includes a CPU, a wireless network interface controller, a near-field wireless communication unit, a storage (a memory, an SSD, an HD, or the like), an input device (including a touch panel), a display device, a camera, a microphone, and the like, and operates on the basis of a program such as an OS, middleware, and various applications. As the display device of the table terminal 32, a display device having a relatively large size is used in order for a display surface to be used as a table top. The table terminal 32 executes a content browsing application or an operation application by the CPU to realize a function for business negotiation with a store staff, and the like. For example, the table terminal 32 has a function of transmitting and receiving information to and from the staff terminal 14 through near-field wireless communication, a function of transmitting and receiving information to and from the customer information management system 20 or the content distribution system 21, a function of browsing recommendation information (content) received from the content distribution system 21 (designation of a favorite product, a request for confirmation of a product, a request for reservation and purchase of a product, input of content keyword), a function of browsing customer information and the like, and a function of transmitting and receiving information to and from the tablet terminal 33. The table terminal 32 can input information for extraction of the recommendation information (content) received from the content distribution system 21 through a recognition process with respect to a two-dimensional barcode or image which is captured by the camera.

The tablet terminal 33 is realized by a tablet type personal computer. The tablet terminal 33 includes a CPU, a wireless network interface controller, a near-field wireless communication unit, a storage (a memory, an SSD, an HD, or the like), an input device (including a touch panel), a display device, a camera, a microphone, and the like, and operates on the basis of a program such as an OS, middleware, and various applications. The tablet terminal 33 executes a content browsing application or an operation application by the CPU to realize a function for business negotiation with a store staff, and the like. For example, the tablet terminal 33 has a function of transmitting and receiving information to and from the staff terminal 14 through near-field wireless communication, a function of transmitting and receiving information to and from the customer information management system 20 or the content distribution system 21, a function of browsing recommendation information (content) received from the content distribution system 21 (designation of a favorite product, a request for confirmation of a product, a request for reservation and purchase of a product, input of a content keyword), a function of browsing customer information and the like, and a function of transmitting and receiving information to and from the table terminal 32. The tablet terminal 33 can input information for extraction of the recommendation information (content) received from the content distribution system 21 through a recognition process with respect to a two-dimensional barcode or image which is captured by the camera.

For example, the mobile apparatus 34 is realized by a tablet type personal computer, a smart phone, and the like. The mobile apparatus 34 can realize the same function as that of the table terminal 32 or the tablet terminal 33 by executing an application that allows the mobile apparatus 34 to function as the customer serving device 16.

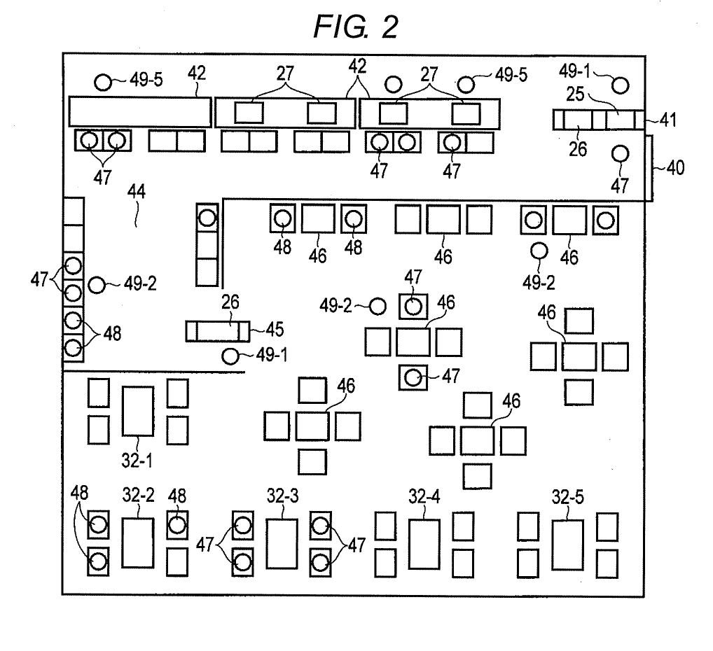

FIG. 2 is a diagram illustrating an example of a situation in which the customer service system 10 of this embodiment is used. FIG. 2 illustrates an example in which the customer service system 10 is used, for example, in a business negotiation room for a customer (member) which is provided to a shop.

For example, the reception terminal 25 and the seat allocation terminal 26 are disposed in a reception counter 41 that is provided in the vicinity of an entrance 40 of a business negotiation room. The reception terminal 25 and the seat allocation terminal 26 which are disposed in the reception counter 41 are operated by a reception attendant 49-1 who is a store staff. The reception attendant 49-1 operates the reception terminal 25 with respect to a customer 47 who enters the room, and performs confirmation of member registration, confirmation of a store visiting purpose, and the like, for example, on the basis of a membership card to input necessary information. In addition, the reception attendant 49-1 operates the seat allocation terminal 26, and carries out allocation of the tablet terminal 33 or the table terminal 32 to the customer 47, or a table allocation procedure to another table seat 46 other than the table terminal 32. The customer 48 who rents the tablet terminal 33 can receive distribution of content for a customer through the tablet terminal 33.

A reservation counseling counter 42 is provided in the vicinity of the reception counter 41. A plurality of procedure terminals 27 are disposed in the reservation counseling counter 42. Each of the procedure terminals 27 is operated by a procedure attendant 49-5 or a customer serving attendant 49-2 who is a store staff.

A waiting space 44 is provided in front of the business negotiation space. A seat for a customer, who waits for an empty seat in the business negotiation space, is provided in the waiting space 44. The customer 48 who rents the tablet terminal 33 can receive business negotiation by the customer serving attendant 49-2 even during waiting in the waiting space 44 by using the tablet terminal 33. In addition, a reception counter 45 is provided in the waiting space 44, and the seat allocation terminal 26 is disposed therein.

For example, a plurality of the table seats 46 and a plurality of the table terminals 32 (32-1, . . . , 32-5) are provided in the business negotiation space. The table terminal 32 is allocated to a customer 47 who does not rent the tablet terminal 33. The customer 47 can receive a service by the customer serving attendant 49-2 while viewing content that is displayed on the table terminal 32. The customer 48 who rents the tablet terminal 33 can receive a service provided by the customer serving attendant 49-2 in the table seat 46 and the table terminal 32. The same content may be distributed to the tablet terminal 33 and the table terminal 32 which are used by the customer 48 from the content distribution system 21, or contents different from each other may be distributed thereto. For example, detailed product information or a plurality of product images, which are difficult to display on one screen in the tablet terminal 33, may be displayed by using a large screen of the table terminal 32.

In addition, the handy terminal 30 (or the mobile apparatus 31) that is carried by the customer serving attendant 49-2 reads out identification information that is inherent to a customer (or the table terminal 32 or the tablet terminal 33 which is used by the customer), and notifies the content distribution system 21 (or the customer information management system 20) of the identification information, thereby displaying information synchronized with recommendation information (content) that is displayed on the tablet terminal 33 (or the table terminal 32) which is used by the customer. However, the handy terminal 30 and the tablet terminal 33 (table terminal 32) can receive different information relating to the same product from the content distribution system 21 and can display contents with different details, respectively. For example, supplementary information and the like, which illustrates details of a product to the customers 47 and 48, can be displayed on the handy terminal 30 that is used by the customer serving attendant 49-2.

In addition, as a store staff, in addition to the customer serving attendant 49-2, an out-of-store sales attendant or a shop attendant is present in a store. The out-of-store sales attendant or the shop attendant may be present not only in the business negotiation room but also in a product shop and the like outside the business negotiation room. Similar to the customer serving attendant 49-2, the out-of-store sales attendant or the shop attendant possesses the handy terminal 30 (or the mobile apparatus 31). The handy terminal 30 that is carried by the out-of-store sales attendant or the shop attendant displays the same content as in the handy terminal 30 (mobile apparatus 31) that is used by the customer serving attendant 49-2 who is in business negotiation with a customer in the business negotiation room, and can receive an instruction (a request for confirmation of a stock, a request for bringing-in of a product to the business negotiation room, and the like) from the customer serving attendant 49-2.

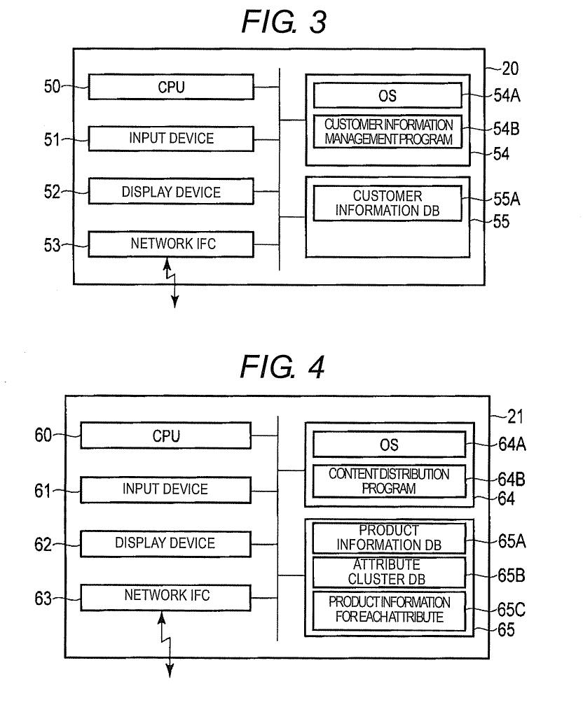

FIG. 3 is a block diagram illustrating an example of a configuration of the customer information management system 20 in this embodiment. The customer information management system 20 illustrated in FIG. 3 illustrates an example of being implemented, for example, by one server (computer).

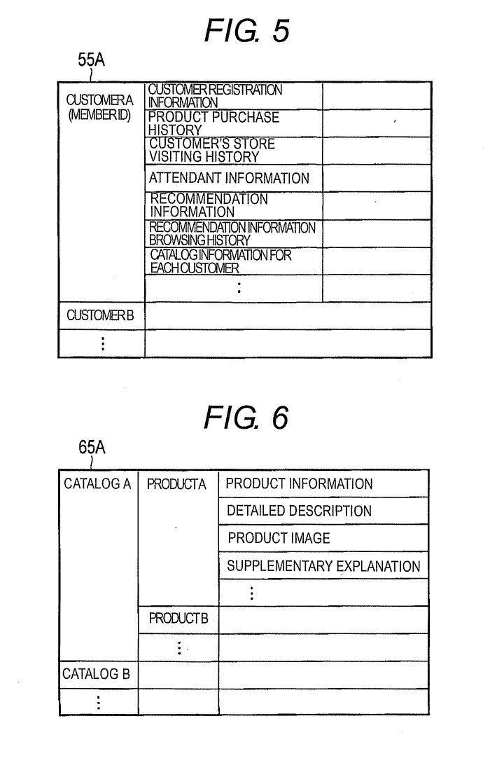

The customer information management system 20 includes, for example, a CPU 50, an input device 51, a display device 52, a network interface controller (IFC) 53, a memory 54, a large-capacity storage 55 (HDD or SSD). The CPU 50 reads out an OS 54A or a customer information management program 54B which is stored in the large-capacity storage 55 into the memory 54 for execution. The CPU 50 executes the customer information management program 54B to realize a function of managing customer information, a product purchase history, a customer's store visiting history, attendant information, information (recommendation information) with respect to a specific product for each customer, a browsing history for the recommendation information, and the like. In addition, a customer information database 55A is recorded in the large-capacity storage 55. Details of the customer information database 55A will be described later (refer to FIG. 5). In addition, as illustrated in FIG. 3, the customer information management system 20 can be realized not only by one server, but also in combination with a plurality of servers or other electronic apparatuses.

FIG. 4 is a block diagram illustrating an example of a configuration of the content distribution system 21 in this embodiment. The content distribution system 21 illustrated in FIG. 4 illustrates an example of being realized, for example, by one server (computer).

For example, the content distribution system 21 includes a CPU 60, an input device 61, a display device 62, a network interface controller (IFC) 63, a memory 64, and a large-capacity storage 65 (HDD or SSD). The CPU 60 reads out an OS 64A or a content distribution program 64B which is stored in the large-capacity storage 65 into the memory 64 for execution. The CPU 60 executes the content distribution program 64B to realize a function of managing information (recommendation information) that relates to a product, a function of extracting a designated customer attribute, a function of managing a cluster, a function of inferring recommendation information, a function of extracting supplementary information, and the like. In addition, a product information database 65A, an attribute cluster database 65B, product information 65C for each attribute, and the like are recorded in the large-capacity storage 65. Details of the product information database 65A, the attribute cluster database 65B, and the product information 65C for each product will be described later. In addition, as illustrated in FIG. 4, the content distribution system 21 can be realized not only by one server, but also in combination with a plurality of servers or other electronic apparatuses.

FIG. 5 is a diagram illustrating an example of customer information that is included in the customer information database 55A of the customer information management system 20 in this embodiment.

For example, pieces of information such as customer registration information, a product purchase history, a customer's store visiting history, attendant information, recommendation information, a recommendation information browsing history, and catalog information for each customer, and the like are registered in the customer information database 55A for each customer (member ID). The member ID is identification information which is inherent to a member and is issued when the customer is registered as a member.

The customer registration information is information (name, age, sex, face image, and the like) of an individual which is provided during member registration. The product purchase history is information relating to a product that was purchased by the customer in the past. The customer's store visiting history is information that is recorded to indicate visiting of the customer to a store or a business negotiation room. The attendant information is information relating to a store staff who serves a customer when the customer visits the business negotiation room. The recommendation information is product-related information which is distributed from the content distribution system 21 to a customer. The recommendation information browsing history is information indicating a history of recommendation information that is browsed by a customer among plural pieces of recommendation information (contents) which are distributed to the customer. The catalog information for each customer is information relating to a product which is registered in a catalog for personal use and which is selected by the customer from catalog-type contents.

FIG. 6 is a diagram illustrating an example of information that is included in the product information database 65A of the content distribution system 21 in this embodiment. The content distribution system 21 of this embodiment can distribute product-related information (recommendation information) to the table terminal 32 or the tablet terminal 33, for example, in a catalog manner.

Information about a plurality of products A, B, . . . is recorded in the product information database 65A for each of a plurality of kinds of catalogs A, B, . . . . For example, with regard to one product A, information such as product information (including a product name, a price, a product model number, a product description, and the like), a detailed description, a product image, and a supplementary description is included. In addition, product-related information may be recorded in the product information database 65A in other formats.

When distributing recommendation information to the table terminal 32 or the tablet terminal 33 which is used by a customer, the content distribution system 21 extracts a product (product cluster) to be recommended to the customer on the basis of customer information, a customer attribute cluster, a product cluster, and the like, and selects only information relating to the product from the product information database 65A to distribute the information. According to this, the content distribution system 21 can selectively provide content relating to a customer's favorite product. Accordingly, the customer can conveniently find a desired product among a number of products on sale in a store with reference to the content (recommendation information).

In addition, the content distribution system 21 can extract a product (product cluster) to be recommended to a customer on the basis of store policy information that is registered in advance by a content providing attendant who is a store staff, and attendant information that is input from the handy terminal 30 (mobile apparatus 31) by the customer serving attendant 49-2 who serves a customer. A sales-strategy product for which the number of sales is desired to be increased on a store side, a product for members only which is prepared by a store for members, and the like are set in the store policy information. For example, the attendant information is additional information that is input from the handy terminal 30 (mobile apparatus 31) by the customer serving attendant 49-2 during customer serving on the basis of information obtained during communication with a customer and the like, and is information indicating a keyword that implies a product, or priority (importance) of additional information (keyword).

In addition, the content distribution system 21 can extract a product (product cluster) to be recommended to a customer on the basis of a request for addition of a customer which is input from the customer serving device 16 by a customer during business negotiation with the customer serving attendant 49-2. The request for addition by a customer can be repetitively input from the customer serving device 16 during customer serving by the customer serving attendant 49-2. For example, the customer can input an image, text data, a voice, and the like, which relate to a desired product, to instruct a keyword that implies a product to the content distribution system 21 as a request for addition by a customer.

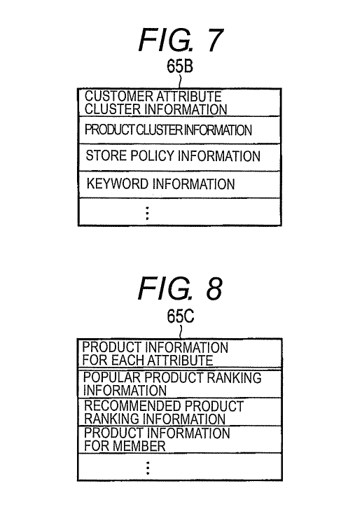

FIG. 7 is a diagram illustrating an example of information that is included in the attribute cluster database 65B of the content distribution system 21 in this embodiment.

For example, customer-information cluster information, product cluster information, store policy information, keyword information, and the like are included in the attribute cluster database 65B. The customer-information cluster information is configured to determine characteristics of a customer and the like on the basis of customer information of the customer, and examples thereof include cluster information such as a population-statistics cluster, a preference cluster, and a behavior cluster. The product cluster information is configured to determine a customer attribute cluster, attendant information, a store policy, and a product group that relates to the request for addition by a customer, and is information that relates to each corresponding product cluster of a plurality of product groups. The store policy information is information indicating a sales-strategy product that is registered by a content providing attendant who is a store staff, a product for members only, and the like. The keyword information is information relating to a keyword that implies a product. The keyword is specified by a text input by the customer serving attendant 49-2 and the like, and an image, a text, a voice, and the like which are designated by a customer.

FIG. 8 is a diagram illustrating an example of the product information 65C for each attribute which is included in the attribute cluster database 65B of the content distribution system 21 in this embodiment.

For example, popular product ranking information, recommended product ranking information, information of a product for members, and the like are included in the product information 65C for each attribute. For example, the product information 65C for each attribute can be registered on the basis of a sales-result of a product which is managed by the POS system 22, and a stock situation that is managed by the stock management system 23. For example, information that is included in the product information 65C for each attribute is used as a store policy, and can be used to extract a product (product cluster) in accordance with a customer.

Next, an operation of the customer service system 10 in this embodiment will be described.

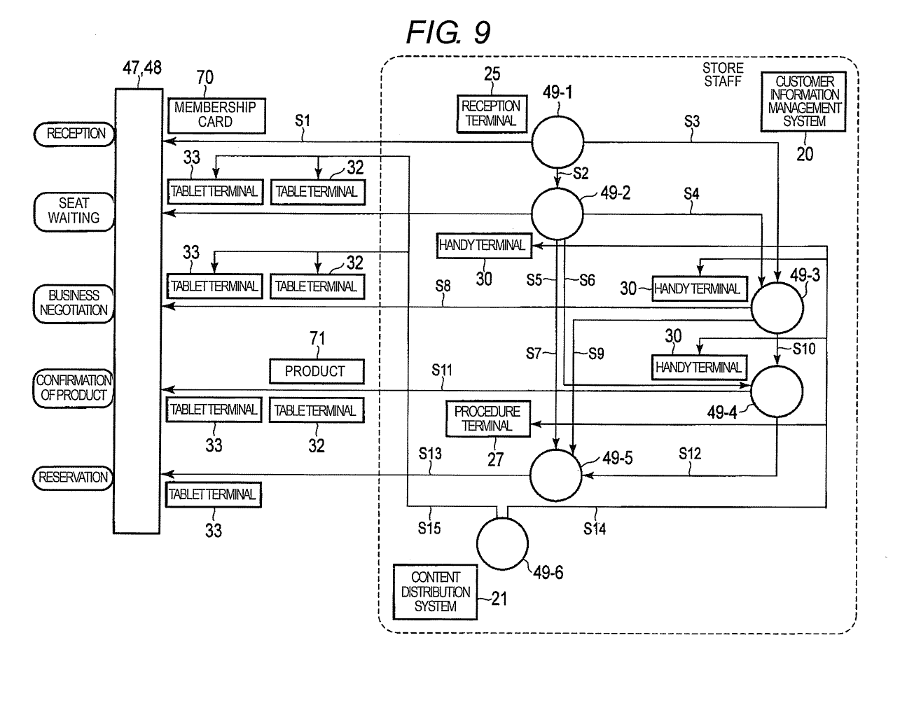

FIG. 9 is a diagram illustrating a flow of information that is transmitted and received between a store staff and a customer in the customer service system 10 in this embodiment.

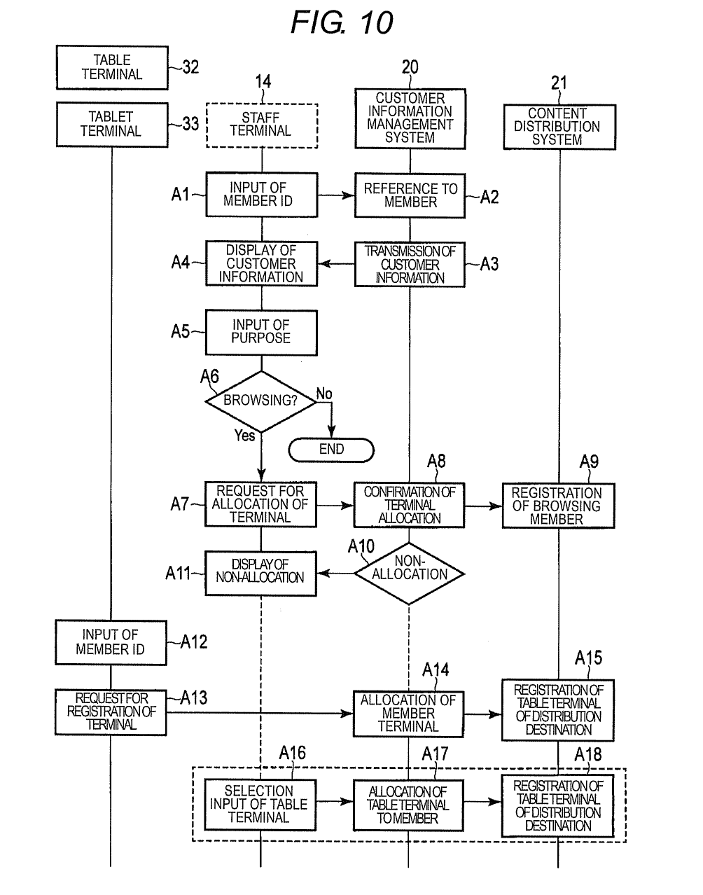

First, a process of allocating the customer serving device 16 (tablet terminal 33, table terminal 32) to a customer who visits the business negotiation room will be described with reference to a flowchart illustrated in FIG. 10.

When a customer visits the business negotiation room, the reception attendant 49-1 acquires authentication information for confirmation of a member from the customer (Act 1 in FIG. 9). For example, the reception attendant 49-1 stores a membership card that is carried by the customer, and inputs a member ID recorded on the membership card by using the reception terminal 25. When the member ID is input, the staff terminal 14 (reception terminal 25) transmits the member ID to the customer information management system 20 (Act A1 in FIG. 10). In addition, the authentication information may be, for example, biometrics information of the customer and the like without limitation to the member ID.

When receiving the member ID from the reception terminal 25, the customer information management system 20 refers to a member on the basis of the member ID (Act A2). That is, the customer information management system 20 searches the customer information database 55A on the basis of the member ID, and extracts customer information that corresponds to the member ID. The customer information management system 20 selects information necessary for a reception procedure from the customer information that is extracted from the customer information database 55A, and transmits the selected information to the reception terminal 25 (Act A3). For example, the customer information management system 20 transmits customer registration information (name, sex, age, face image, and the like), a customer's store visiting history, attendant information, and the like which are included in the customer information.

The reception terminal 25 receives the customer information from the customer information management system 20, and displays the customer information on a display device (Act A4).

Next, the customer serving attendant 49-2 confirms whether or not the customer is a member on the basis of the information that is displayed on the reception terminal 25, and asks the customer a store visiting purpose, and the like. For example, as the store visiting purpose, a product which is desired to be purchased, purchase of a present, and the like may be exemplified. The reception terminal 25 inputs information that indicates the purpose of the customer by operation of the customer serving attendant 49-2 (Act A5). The reception terminal 25 determines whether or not it is necessary to browse content that is distributed from the content distribution system 21 on the basis of the purpose of the customer (Act A6). Here, if it is determined that the browsing is not necessary, the reception terminal 25 terminates the process of allocating the tablet terminal 33.

On the other hand, if it is determined that browsing is necessary, the reception terminal 25 transmits a request for allocation of a terminal to a customer (member ID) who is a current reception target to the customer information management system 20 (Act A7). With respect to the request for allocation of a terminal, the customer information management system 20 confirms whether or not a terminal is allocated to the target customer (member ID) (Act A8). Here, if it is determined that a terminal is not allocated (Act A10), the customer information management system 20 notifies the reception terminal 25 of the fact that the allocation of a terminal is not performed. The reception terminal 25 displays details of notification which indicate that the tablet terminal 33 is not allocated to the target customer (Act A11).

In addition, in response to the request for allocation of a terminal from the reception terminal 25, the customer information management system 20 notifies a customer (member ID), who is a reception target, of the content distribution system 21. The content distribution system 21 registers the customer (member ID), who is notified from the customer information management system 20, as a customer who browses content about a product (Act A9).

When confirming that the tablet terminal 33 is not allocated to a customer through the display of the reception terminal 25, the reception attendant 49-1 inputs a member ID (may be other inherent information such as the name of the customer) of the customer to the tablet terminal 33 to be rented by the customer, and gives an instruction of registration of a terminal (Act A12). In response to operation by the reception attendant 49-1, the reception terminal 25 transmits the member ID that is input and the request for registration of a terminal to the customer information management system 20 (Act A13).

The customer information management system 20 allocates the tablet terminal 33, about which the request for registration of a terminal is made, to a customer (member ID) who is a target of the request for allocation of a terminal which is previously received (Act A14). The customer information management system 20 notifies the content distribution system 21 of the tablet terminal 33 that is allocated to the customer (member ID). The content distribution system 21 registers the tablet terminal 33 that is a content distribution destination in correspondence with a customer who browses the content. According to this, the content distribution system 21 distributes information (recommendation information), which relates to a product that is recommended to a customer, to the tablet terminal 33 that is rented by the customer, and can receive a request made by the customer from the tablet terminal 33.

In addition, the table terminal 32 may be allocated to a customer. When the table terminal 32 to be allocated to a customer is selected by operation of the reception attendant 49-1 (Act A16), the seat allocation terminal 26 transmits the request for allocation of a table terminal to the customer information management system 20 in combination with information (table identification information) indicating the table terminal 32 and a customer (member ID).

The customer information management system 20 allocates the table terminal 32, which is indicated by the table identification information received from the seat allocation terminal 26, to a customer (member ID) who is a target of the request for allocation of a terminal which is previously received (Act A17). The customer information management system 20 notifies the content distribution system 21 of the table terminal 32 that is allocated to the customer (member ID). The content distribution system 21 registers the table terminal 32 that is a content distribution destination in correspondence with a customer who browses the content. According to this, the content distribution system 21 distributes information (recommendation information), which relates to a product that is recommended to a customer, to the table terminal 32 that is allocated to the customer, and can receive a request made by the customer from the table terminal 32.

In addition, the reception attendant 49-1 may allocate the table seat 46 to the customer who rents the tablet terminal 33. In this case, the seat allocation terminal 26 inputs table identification information (table number and the like) indicating the table seat 46 by operation of the reception attendant 49-1 and notifies the customer information management system 20 of the information. The customer information management system 20 transmits the table identification information, and customer registration information (name, sex, age, and the like), a customer's store visiting history, attendant information, and the like, which are included in customer information, to the staff terminal 14. According to this, for example, the handy terminal 30 that is carried by the customer serving attendant 49-2 displays the table identification information and the customer information. The customer serving attendant 49-2 confirms the table identification information and the customer information which are displayed on the handy terminal 30, and can serve a customer 47 to whom the tablet terminal 33 is not rented.

In addition, on the basis of information that is input from the reception terminal 25 and the seat allocation terminal 26 during reception, as illustrated in FIG. 9, the customer information management system 20 notifies the staff terminal 14, which is carried by a store staff (for example, the customer serving attendant 49-2, and the out-of-store sales attendant 49-3), of a customer's visiting (Act 2, Act 3). For example, the customer information management system 20 gives a purpose notification (including schedule confirmation of out-of-store sales, and the like) to instruct a store staff to serve a customer in addition to notification of a room visiting customer to the staff terminal 14.

In addition, in the above description, the table terminal 32 or the tablet terminal 33, which is prepared on a store side, is allocated to a customer. However, the mobile terminal 34 such as a smart phone that is carried by the customer may be allowed to be used as the customer serving device 16. In this case, the reception terminal 25 installs an application program (a content browsing application or an operation application) to realize substantially the same function as that of the tablet terminal 33, in the mobile terminal 34 of the customer. When executing the application program, the mobile terminal 34 can communicate with the customer information management system 20 or the content distribution system 21 through a network in a resting room.

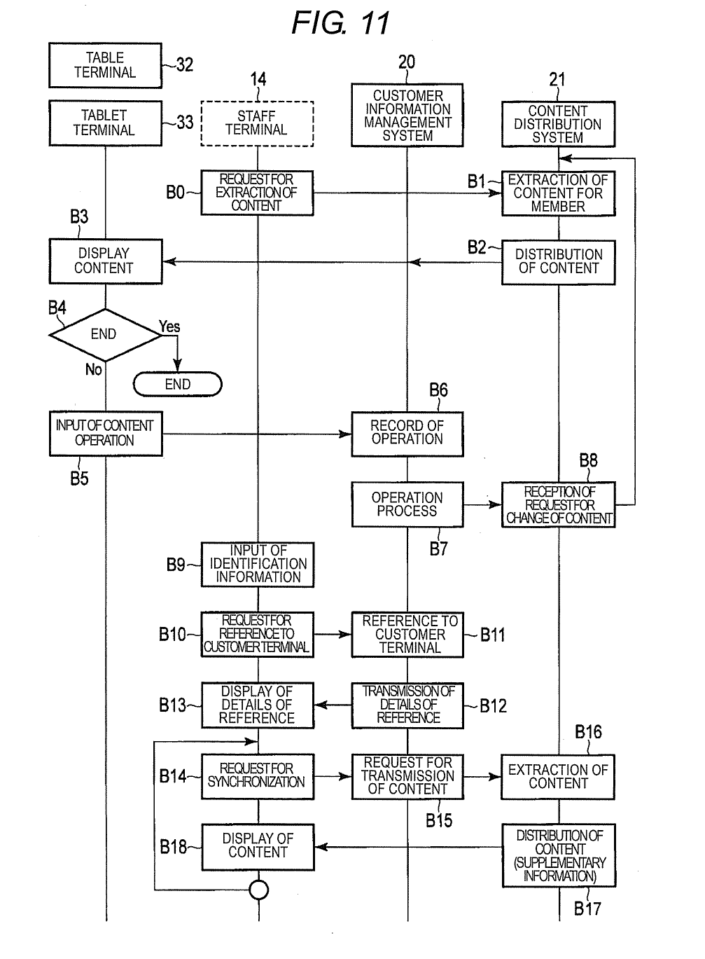

Next, description will be given of a process of synchronizing content that is displayed on the tablet terminal 33 (table terminal 32) that is rented to a customer, and the handy terminal 30 that is held by the customer serving attendant 49-2 who serves a customer with reference to a flowchart illustrated in FIG. 11.

After confirming a room visiting purpose of a customer 47, and the like, when it is determined that browsing preparation of content for a customer is necessary, the reception attendant 49-1 gives an instruction of a request for extraction of content from the reception terminal 25 (or the seat allocation terminal 26). The reception terminal 25 transmits the request for extraction of content to the content distribution system 21 (Act B0). When receiving the request for extraction of a content, the content distribution system 21 extracts content for a customer (member) who browses content (Act Si).

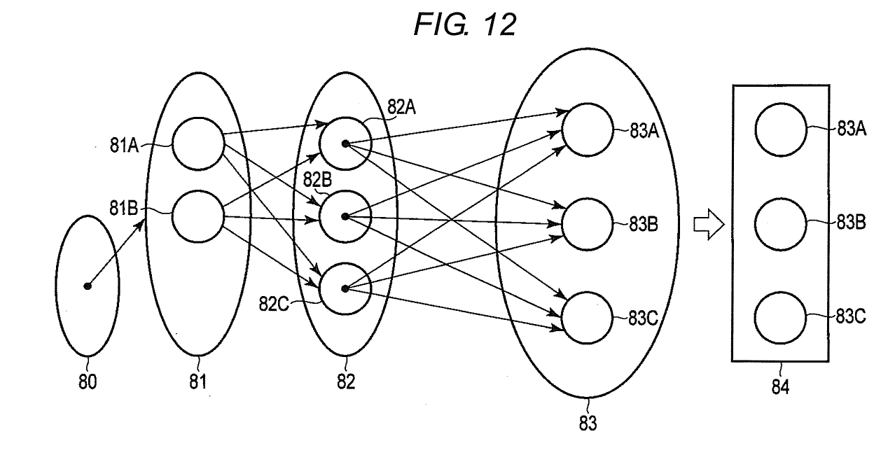

FIG. 12 is a diagram illustrating extraction of content for a customer by the content distribution system 21 in this embodiment. For example, as illustrated in FIG. 12, the content distribution system 21 extracts a product group (product cluster) that is expected as a favorite one of a customer by using a cluster analysis method on the basis of correlation intensity (or distance) between a customer attribute cluster 82 that corresponds to a customer and a product cluster 83. In addition, the content distribution system 21 creates content for the product group (product cluster) that is expected as a favorite one of a customer, that is, information to be displayed on the staff terminal 14, the table terminal 32, or the tablet terminal 33, and distributes the information. In this embodiment, it is assumed that the content that is distributed from the content distribution system 21 is created, for example, in a product catalog format.

First, the content distribution system 21 extracts customer information 81 on the basis of a member ID 80 of a customer. Examples of the customer information 81 include information 81A during registration, a purchase history 81B, and the like. The content distribution system 21 determines the customer attribute cluster 82 that corresponds to the information 81A during registration or the purchase history 81B of the customer, and extracts a product cluster 83 with highest correlation intensity with the customer attribute cluster 82.

Examples of the customer attribute cluster 82 include a population-statistics cluster 82A, a preference cluster 823, a behavior cluster 82C, a hobby, life style information, tourist information, and the like. For example, if information such as a “woman” in “the age of forties” is obtained from the information 81A of a customer during registration, and information on a “purchased product brand” and “the number of times of purchase in a year” is obtained from the purchase history 81B, the content distribution system 21 increases the intensity with respect to a product cluster of a product as a favorite one of the “woman” in “the age of forties” on the basis of the population-statistics cluster 82A, increase the intensity with respect to a product cluster of a product corresponding to the “purchased product brand” on the basis of the preference cluster 82B, and increases the intensity with respect to a product cluster of a product that is purchased at frequency in accordance with “the number of times of purchase in a year” on the basis of the behavior cluster 82C.

The content distribution system 21 calculates the intensity between the respective clusters 82A, . . . . of the customer attribute cluster 82, and the clusters 83A, 83B, 83C, . . . of the product cluster 83 which correspond to respective products, and extracts high-ranking product clusters in which the sum of the intensity between the respective clusters takes a high rank determined in advance. In FIG. 12, as a product cluster 84 that is extracted, for example, product clusters 83A, 83B, and 83C in a third place on a high-ranking side are illustrated. The content distribution system 21 creates content (product catalog) with respect to a product corresponding to each of the product clusters 83A, 83B, and 83C as recommendation information for each customer.

In addition, the content distribution system 21 records a product cluster that is extracted, details of intensity with a customer attribute cluster that is correlated with the product cluster, high-ranking customer attribute cluster in the details, details of intensity of a customer attribute that is correlated with the customer attribute cluster, high-ranking customer attribute information in the details, and the like as supplementary information to be distributed to the staff terminal 14. The content distribution system 21 provides a selection factor of a process of extracting the product cluster, or the degree of an effect by the selection factor to a store staff such as the customer serving attendant 49-2 as the supplementary information (processes in Act 317, and Act 318 to be described later). According to this, explanation for a product (content) that is recommended to a customer during customer serving can be made.

The content distribution system 21 distributes content (recommendation information) for each customer to the tablet terminal 33 (or the table terminal 32) that is rented to the customer (Act 32). When receiving the content (recommendation information) that is distributed from the content distribution system 21, the tablet terminal 33 displays the content on a display device in a catalog format (Act 33).

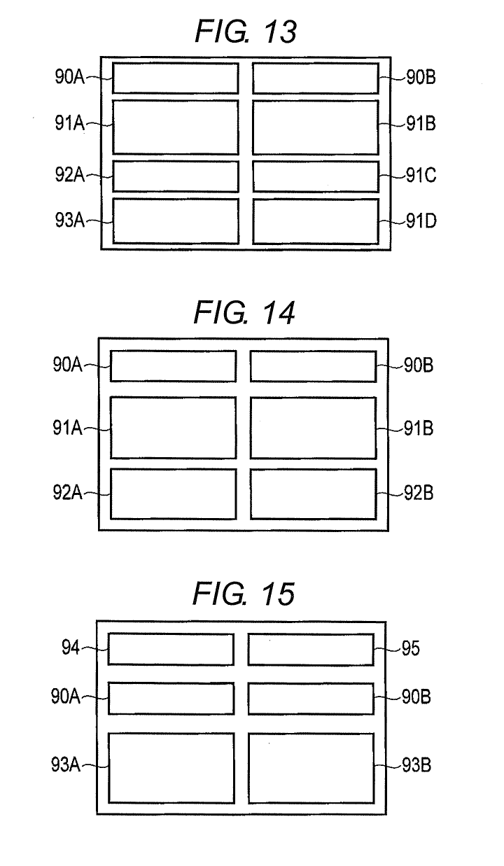

FIG. 13 and FIG. 14 are diagrams illustrating a display example of content that is displayed on the tablet terminal 33 in this embodiment. FIG. 13 and FIG. 14 illustrate a display example in which product catalogs for two products (a product A, and a product B) are disposed on left and right sides on one screen in the tablet terminal 33.

In FIG. 13, product title and outline 90A, a product photograph 91A, a detailed product explanation 92A, and a supplementary information explanation 93A are displayed with respect to the product A, and product title and outline 90B, a product photograph 91B, a detailed product explanation 928, and a supplementary information explanation 93B are displayed with respect to the product B. In this case, a lot of pieces of information are displayed on one screen, and thus a character size of an explanatory note or an image size becomes small. According to this, some customers may feel that it is difficult to see details of the content.

FIG. 14 displays the product title and outline 90A, the product photograph 91A, and the detailed product explanation 92A with respect to the product A, and the product title and outline 908, the product photograph 918, and the detailed product explanation 92B with respect to the product B. In a display format illustrated in FIG. 14, the supplementary information explanations 93A and 938 are omitted from a display format illustrated in FIG. 13, and thus the space of the product photographs 91A and 91B, and the space of the detailed product explanations 92A and 92B can be enlarged. Accordingly, it is possible to make the details of the content easy to see. Basically, the customer service system 10 of this embodiment displays content on the tablet terminal 33 (table terminal 32) in the display format illustrated in FIG. 14. The supplementary information explanations 93A and 93B which are omitted from the display on the tablet terminal 33 can be displayed on the staff terminal 14 by synchronizing the tablet terminal 33 and the staff terminal 14 with each other as described later.

FIG. 15 illustrates an example of displaying content, which is synchronized with the tablet terminal 33, on the staff terminal 14 (handy terminal 30) in this embodiment.

As illustrated in FIG. 15, the handy terminal 30 displays the product title and outline 90A and 90B, and the supplementary information explanations 93A and 93B in correspondence with the contents of the products A and B which are displayed on the tablet terminal 33. In addition, the handy terminal 30 displays a device designation area 95 configured to display a button that is used to designate the customer serving device 16 that is used by a customer who is a serving target of the customer serving attendant 49-2, identification information of the customer serving device 16 (table terminal 32, or the tablet terminal 33) whose synchronization is set, and the like. When being synchronized with the tablet terminal 33, the handy terminal 30 displays member information 94 with respect to a current customer who is a serving target.

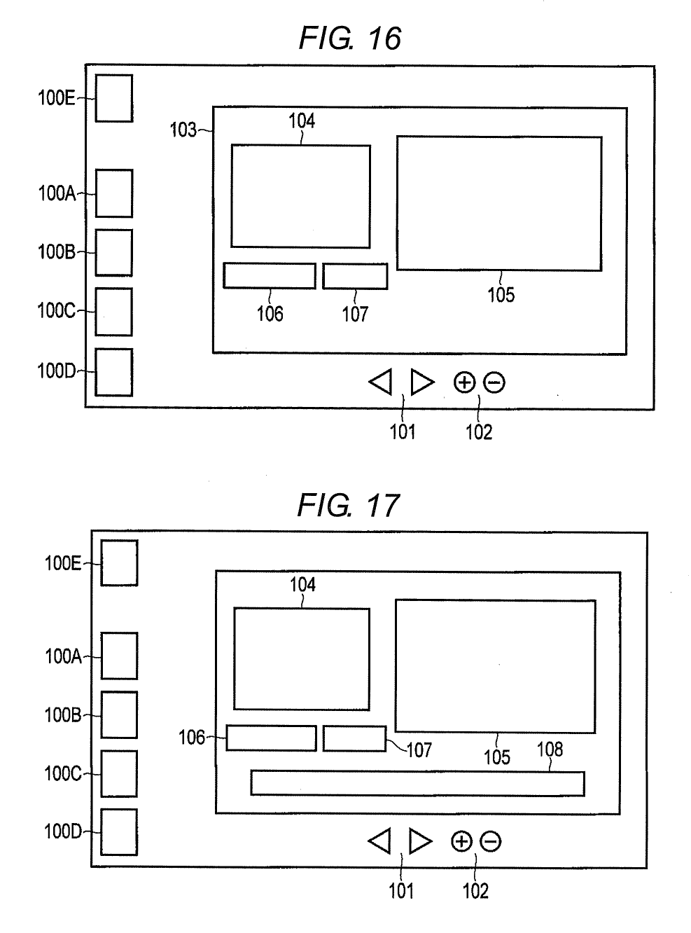

The tablet terminal 33 can change displayed details by operation with respect to the content before content browsing termination is instructed by the customer (Act B4). For example, a button, which is used for selection of the kind of catalogs, page switching, addition of a favorite one (catalog for each customer) with respect to content (product) that is displayed, and instruction of purchase of a product and the like, is added to the content that is displayed on the tablet terminal 33 (refer to FIG. 16). A customer can operate the button by touching a display surface of the tablet terminal 33 with a fingertip. When the button that is added to the content is operated by the customer (Act B5), the tablet terminal 33 notifies the customer information management system 20 of details of the operation.

The customer information management system 20 records the details of the operation performed by the customer (Act B6) and executes a process in response to the operation (Act B7). For example, if addition of a favorite one (catalog for each customer) is instructed, the customer information management system 20 performs a process of adding a product to catalog information for each customer. In addition, if purchase of a product is instructed, the customer information management system 20 transmits information (customer information, product information, and the like), which is necessary to carry out a product purchase procedure, to the procedure terminal 27.

In addition, a content change such as selection of the kind of catalogs and page switching is instructed (if a request for change of content is made from the customer serving device 16), the customer information management system 20 transmits the request for change of content to the content distribution system 21. When receiving the request for change of content (Act B8), the content distribution system 21 extracts content to be newly distributed to a customer (Act B1) in accordance with details of the request, and distributes the content to the tablet terminal 33 (Act B2) as described above.

FIG. 16 is a diagram illustrating a display example of content that is displayed on the tablet terminal 33 in this embodiment.

Content 103 of one product is included in a display format illustrated in FIG. 16. The content 103 includes product title and outline 104, and a product photograph 105. In addition, a page switching button 101 that is used to give an instruction of page-switching, and a scaling button 102 that is used to give an instruction of enlargement or reduction of display are provided on a lower side of the content 103. In addition, a plurality of catalog buttons 100A, 100B, 100C, and 100D for selection of a catalog and a catalog button 100E which is configured to select a catalog for each customer, are provided on a left side of the content 103.

Furthermore, a “favorite” button 106 and a “purchase” button 107 are added to the content. In addition, if the “favorite” button 106 is operated, as illustrated in FIG. 17, the tablet terminal 33 displays, for example, a message 108 of “addition to a catalog for each customer has been completed”. In addition, in addition to the button illustrated in FIG. 16, it is possible to add buttons, which make a request for other processes, such as a “spot check” button that is used to make a request for confirmation of a real product, and a “reservation button” that is used to give an instruction of reservation for purchase of a product.

In this manner, when renting the tablet terminal 33, a customer can browse content (recommendation information) relating to a product that is extracted for customers in a catalog format. The customer can browse information relating to a product in an arbitrary manner, or can register a product to a favorite one (catalog for each customer) through operation with respect to the tablet terminal 33 during waiting in the waiting space 44 for an empty seat or when taking a seat in a business negotiation space.

A customer who is shown in the business negotiation space can continue browsing in the waiting space 44. In addition, when being allocated to the table terminal 32, the customer can browse content not only in the tablet terminal 33 but also in the table terminal 32. Content that is displayed on the table terminal 32 is provided with a button that is used to input operation by the customer, and the like similar to the above-described tablet terminal 33. In this case, when content is changed by operation with respect to the table terminal 32, content that is displayed on the tablet terminal 33 is changed in conjunction with the change.

In addition, the content distribution system 21 may be configured to distribute contents, which are different from each other, to the tablet terminal 33 and the table terminal 32. For example, content relating to a product that is selected by a customer is displayed on the tablet terminal 33, and contents of additional products relating to the product that is displayed on the tablet terminal 33 are displayed on the table terminal 32. According to this, contents of a plurality of products are simultaneously displayed by effectively using a large display screen of the table terminal 32, and thus it is possible to make product comparison and the like by a customer easy.

When sitting on the table seat 46 or the table terminal 32, a customer can receive service by the customer serving attendant 49-2 or the out-of-store sales attendant 49-3. For example, the customer serving attendant 49-2 takes a procedure to synchronize content that is displayed on the tablet terminal 33 (table terminal 32) that is used by a customer and content that is displayed on the handy terminal 30 before customer serving. Hereinafter, description will be made with reference to a case where a customer uses the tablet terminal 33 as an example. It is assumed that the table terminal 32 is used in the same manner as the tablet terminal 33, and thus description thereof will not be repeated.

First, the handy terminal 30 inputs identification information configured to specify the tablet terminal 33 that is used by a customer, or the customer through operation of the customer serving attendant 49-2 (Act B9). For example, as the identification information, a terminal-inherent two-dimensional code (QR code (registered trademark) and the like) that is allocated to the tablet terminal 33, table identification information (table number and the like), a member ID, a member's name, table position information, and the like can be used. For example, the two-dimensional code can be input by capturing an image by using a camera that is provided to the handy terminal 30. In addition, the two-dimensional code may be displayed on the tablet terminal 33. For example, the other pieces of information can be input by the customer serving attendant 49-2 through operation of the handy terminal 30. In addition, when approaching the tablet terminal 33 by the customer serving attendant 49-2, the handy terminal 30 may receive identification information of the tablet terminal 33 through near-field wireless communication.

The handy terminal 30 transmits the identification information that is input, and a request for reference to a customer terminal to the customer information management system 20 (Act B10). The customer information management system 20 refers to the tablet terminal 33 on the basis of the identification information, and extracts information (table identification information or position information) with respect to the tablet terminal 33, or customer registration information (name, sex, age, face image, and the like), a customer's store visiting history, attendant information, and the like which are included in the customer information with respect to a customer that uses the tablet terminal 33 (Act B11). The customer information management system 20 transmits details of the reference which are extracted on the basis of the identification information to the handy terminal 30 (Act B12).

The handy terminal 30 displays the details of reference which are received from the customer information management system 20 (Act B13). The customer serving attendant 49-2 can confirm whether or not the customer information management system 20 is correctly notified of the tablet terminal 33 that is used by a customer with reference to the details of the reference which are displayed on the handy terminal 30.

Here, the customer serving attendant 49-2 operates the handy terminal 30 to give an instruction for the handy terminal 30 to make a request for synchronization with the tablet terminal 33 that is used by the customer. That is, an instruction is given in order for content with respect to the same product to be displayed simultaneously on the tablet terminal 33 and the handy terminal 30. In response to the operation by the customer serving attendant 49-2, the handy terminal 30 transmits the content synchronization request to the customer information management system 20 (Act B14).

When receiving the content synchronization request, first, the customer information management system 20 transmits information indicating the tablet terminal 33 that is referred to on the basis of the identification information, and a request for transmission of content to the content distribution system 21 (Act B15).

The content distribution system 21 determines a product corresponding to the content (recommendation information) that is distributed to the tablet terminal 33 on the basis of the information which is received, from the customer information management system 20 and indicates the tablet terminal 33. The content distribution system 21 extracts content for a store staff (for example, the customer serving attendant 49-2) which corresponds to the product that is determined (Act B16), and distributes the extracted content to the handy terminal 30 that transmits the request for synchronization (Act B17). For example, as illustrated in FIG. 15, member information, supplementary information explanation, and the like, which are not displayed on the tablet terminal 33, are included in the handy terminal 30 that is used by the customer serving attendant 49-2. The handy terminal 30 displays the content that is received from the content distribution system 21 on a display device (Act B18).

In addition, in the example illustrated in FIG. 11, the customer serving attendant 49-2 gives an instruction for the handy terminal 30 to make a request for synchronization, and thus the handy terminal 30 displays content of the same product as in content that is displayed on the tablet terminal 33 that is used by a customer. However, after the synchronization request is received at first, and the handy terminal 30 and the tablet terminal 33 (table terminal 32) are correlated with each other, although the customer serving attendant 49-2 does not give an instruction for the handy terminal 30 to make a request for synchronization, the content distribution system 21 may be configured to automatically switch the content of the handy terminal 30 to details corresponding to the same product in response to change in content that is displayed on the tablet terminal 33 (table terminal 32).

In addition, the content distribution system 21 may be configured not only to switch content of the handy terminal 30 in response to switching of content in the tablet terminal (table terminal 32), but also to automatically switch content of the tablet terminal 33 (table terminal 32) in response to switching of content in the handy terminal 30. According to this, content of a product, which is desired to be browsed to a customer, can be displayed on the tablet terminal 33 (table terminal 32) through operation of the handy terminal 30 by the customer serving attendant 49-2.

In this manner, when the customer serving attendant 49-2 serves a customer, the tablet terminal 33 that is used by the customer, and the handy terminal 30 that is used by the customer serving attendant 49-2 are synchronized with each other, and thus content with respect to the same product can be simultaneously displayed without complicated operation. For example, it is not necessary for the customer serving attendant 49-2 to perform operation of confirming a product that is browsed by a customer in the tablet terminal 33, and of switching a page of a product catalog that is displayed on the handy terminal 30 to find content of the same product. According to this, labor of the customer serving attendant 49-2 is greatly reduced, and thus it is possible to shorten time taken to operate the handy terminal 30.

In addition, the handy terminal 30 displays content with respect to the same product in synchronization with the tablet terminal 33, but may display contents including different details. For example, if supplementary information with respect to a product which is not displayed on the tablet terminal 33 is displayed on the handy terminal 30, the customer serving attendant 49-2 can provide detailed explanation with respect to the product to a customer with reference to the supplementary information.

For example, the content distribution system 21 creates content (supplementary information) for a store staff on the basis of a selection factor of a process of extracting a product cluster during creation of content (product catalog) in correspondence with a customer, or the degree of an effect by the selection factor, and distributes the content that is created to the handy terminal 30. Specifically, for example, a message of “suggestion of 00 bag 00 series with a 00 brand is intended to notify that the bag series are high-ranking items and the brand is a high-ranking brand in popularity ranking for married women in the age of forties, the brand is one of customer's favorite brands, the customer purchases approximately two bags in a year, and it is about time to purchase a bag” is created.

After confirming the supplementary information (message) that is displayed on the handy terminal 30, the customer serving attendant 49-2 can provide a detailed explanation to a customer about the reason for recommendation of a product in a product catalog displayed on the tablet terminal 33. According to this, the customer serving attendant 49-2 can easily prompt the customer to purchase the product.

In addition, the above description is made on the assumption that one customer serving attendant 49-2 serves one customer. However, the customer serving attendant 49-2 may serve a plurality of customers who sit on a plurality of different table seats 46 or table terminals 32. According to this, when correlating the handy terminal 30 that is used by the customer serving attendant 49-2 and the tablet terminal 33 that is used by a customer in response to the request for synchronization which is transmitted from the handy terminal 30, the content distribution system 21 records correspondence between the handy terminal 30 and the tablet terminal 33. When serving the plurality of customers, the customer serving attendant 49-2 may synchronize the tablet terminals 33 which are used by the respective customers, and the handy terminal 30. The handy terminal 30 displays the identification information (or customer registration information capable of identifying customers, and the like) of the tablet terminal 33, in which the correspondence is recorded by the content distribution system 21, for example, in the device designation area 95 illustrated in FIG. 15. The customer serving attendant 49-2 selects identification information that corresponds to a customer that is displayed on the device designation area 95 in accordance with a customer who is a serving target. The handy terminal 30 notifies the content distribution system 21 of the identification information that is selected by the customer serving attendant 49-2. In accordance with the identification information that is notified from the handy terminal 30, the content distribution system 21 switches content to be distributed to the handy terminal 30 to be synchronized with the tablet terminal 33 corresponding to the identification information.

In this manner, the customer serving attendant 49-2 can serve the plurality of customers by using one handy terminal 30. When customer serving is completed, the customer serving attendant 49-2 selects identification information that is displayed in the device designation area 95 of the handy terminal 30, and gives an instruction of termination of customer-serving. The handy terminal 30 notifies the content distribution system 21 of the identification information and the termination of the customer serving. In response to the notification of termination of customer serving, the content distribution system 21 deletes the correspondence between the table terminal 32 and the tablet terminal 33 which is indicated by the identification information.

In addition, in the above description, the description is given of the synchronization between the tablet terminal 33 (table terminal 32) that is used by a customer, and the handy terminal 30 that is used by the customer serving attendant 49-2. However, the handy terminals 30 which are used by the other store staffs can be synchronized in this manner.

The out-of-store sales attendant 49-3 illustrated in FIG. 9 displays content on the handy terminal 30 in synchronization with the table terminal 32 that is used by a customer during business negotiation with a customer similar to the above-described customer serving attendant 49-2, and thus the out-of-store sales attendant 49-3 can proceed the business negotiation while browsing the content displayed on the handy terminal 30 (Act 8).

In addition, the handy terminal 30 that is used by the customer serving attendant 49-2 or the out-of-store sales attendant 49-3, and for example, the handy terminal 30 that is used by the shop attendant 49-4, and the procedure terminal 27 that is used by the procedure attendant 49-5 can communicate with each other through the customer information management system 20 or the content distribution system 21. For example, the customer serving attendant 49-2 or the out-of-store sales attendant 49-3 can notify the shop attendant 49-4 or the procedure attendant 49-5 of a request for confirmation of a stock, a request for bringing-in of a real product through the handy terminal 30 during business negotiation with a customer, and the like (Act 6, Act 7, Act 9, and Act 10). In a state in which content of a product which is considered to be purchased by a customer is displayed, the customer serving attendant 49-2 gives an instruction of a request for confirmation of a stock or a request for bringing-in of a real product. The handy terminal 30 notifies the content distribution system 21 of the product information corresponding to the product content, and the request for confirmation of a stock or the request for bringing-in of a real product. The content distribution system 21 distributes content corresponding to the product information, which is received from the handy terminal 30, to the handy terminal 30 that is used by the shop attendant 49-4 or the procedure terminal 27, and notifies the handy terminal 30 or the procedure terminal 27 of the request for confirmation of a stock or the request for carrying-out of a real product.

In addition, the content distribution system 21 distributes only the content of the product which is considered to be purchased by the customer to the handy terminal 30 that is used by the shop attendant 49-4 or the procedure terminal 27, and also displays the content of the product relating to the product which is considered to be purchased by the customer in combination with each other. Examples of the relating product include a product having a size or a color which is different from that of the product which is considered to be purchased by the customer, a product that is used in combination with the product which is considered to be purchased by the customer, a product which relates to the product considered to be purchased by the customer and is in sales-promotion in a store, and the like. If the content of the relating product is also distributed, for example, the shop attendant 49-4 can recommend not only the product which is considered to be purchased by the customer but also the relating product 71 (real product) to a customer in a state of bringing-in the relating product 71 to the business negotiation room (Act 11). In addition, if there is no stock of the product which is considered to be purchased by the customer, the procedure attendant 49-5 may recommend the relating product (real product) to the customer in a state of bringing-in the relating product to the business negotiation room.

In addition, when a customer determines reservation or purchase of a product, instruction of the reservation or purchase of the product can be given from the tablet terminal 33 that is used by the customer, or the handy terminals 30 which are used by the customer serving attendant 49-2, the out-of-store sales attendant 49-3, and the shop attendant 49-4 (Act 12). The customer information management system 20 and the content distribution system 21 are notified of the instruction of the reservation or the purchase of the product. Accordingly, information (a product name, a product model number, and the like) with respect to the product that is a purchase target, or the information relating to the customer is transmitted from the customer information management system 20 and the content distribution system 21 to the procedure terminal 27. According to this, it is not necessary for the customer or the procedure attendant 49-5 to input again various pieces of information to the procedure terminal 27 for a product purchase procedure. The procedure attendant 49-5 can give a confirmation for the reservation or the purchase of the product to the customer while viewing the information relating to the product or the information relating to the customer which is displayed on the procedure terminal 27 (Act 13).

In this manner, if the handy terminal 30 that is used by a store staff and the tablet terminal 33 (table terminal 32) that is used by a customer are synchronized with each other, information relating to a customer who is a serving target, or information relating to a product can be shared. Accordingly, a procedure work such as reception of a customer, customer serving, business negotiation, confirmation of a product, and payment is made to be efficient, and thus it is possible to reduce a work load on a customer and a store staff.

Next, description will be given of change of content (recommendation information) that is provided from the content distribution system 21 to the tablet terminal 33 (table terminal 32).

In the above description, as illustrated in FIG. 9, the content distribution system 21 extracts a product cluster of a product that is recommended to a customer in correspondence with the member ID 80 of the customer who visits the business negotiation room on the basis of a relationship between the customer information 81, the customer attribute cluster 82, and the product cluster 83. The customer information 81 and the customer attribute cluster 82 are not information that greatly varies with the passage of time. Accordingly, correlation between the customer attribute cluster 82 and the product cluster 83 does not greatly vary, and thus a product that is recommended to a customer always becomes the same.

The customer service system 10 of this embodiment can change a product (recommendation information) that is recommended to a customer by inputting information (attendant information) which is obtained by a store staff during conversation with the customer, or information (store policy information) indicating a store policy from the staff terminal 14. Examples of the attendant information include a demand of the customer, preference of the customer, a store visiting purpose, and the like. In addition, examples of the store policy information include a sales-strategy product for which the number of sales is desired to be increased on a store side, a product for members only which is prepared by a store for members, and the like.

In addition, for example, if an additional request that is excited when a customer receives a service by a store staff is input from the tablet terminal 33 (table terminal 32), the customer service system 10 can also change a product (recommendation information) that is recommended to the customer.

That is, the customer service system 10 in this embodiment can change content (recommendation information) that is distributed to the tablet terminal 33 (table terminal 32) that is used by the customer on the basis of various pieces of information which are input from a plurality of the staff terminals 14 and the tablet terminal 33 (table terminal 32). According to this, information of a product that matches the demand of the customer can be appropriately provided in order for the customer to have a desire to purchase the product.

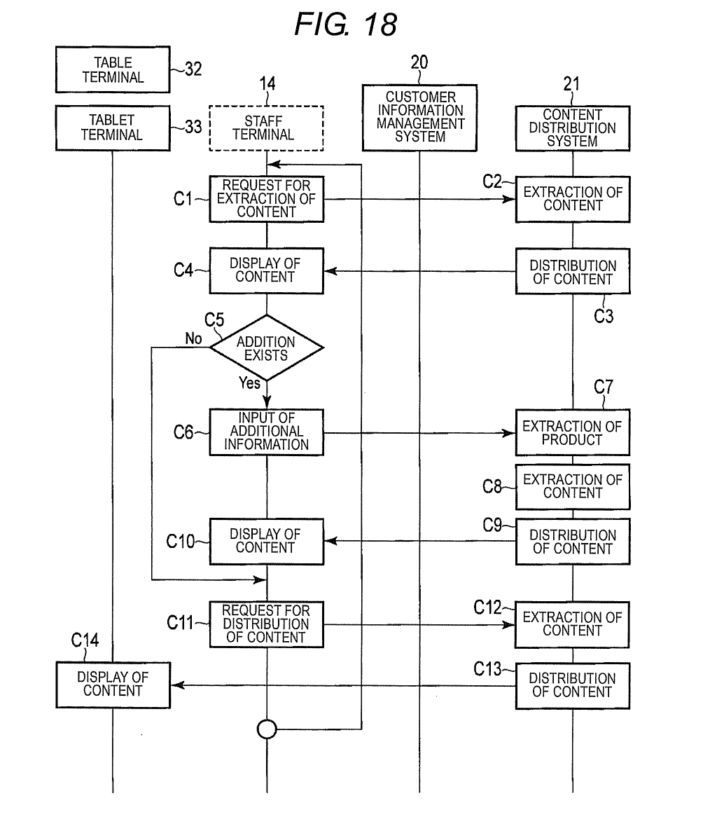

First, description will be given of a process of changing content (recommendation information) on the basis of information that is input from the staff terminal 14 with reference to a flowchart illustrated in FIG. 18.

Here, description will be made with reference to a case where attendant information (additional information) is input by the customer serving attendant 49-2 during customer serving as an example. If it is necessary to browse content of a product to be recommended to a customer who is a serving target, the customer serving attendant 49-2 gives an instruction for the handy terminal 30 to make a request for extraction of content. The handy terminal 30 transmits the request for exaction of content to the content distribution system 21 in response to the instruction from the customer serving attendant 49-2 (Act C1). The content distribution system 21 extracts content with respect to the product, which is recommended to the customer (member) who browses the content, in response to the request for extraction of content (Act C2). The content distribution system 21 distributes the content that is extracted to the handy terminal 30 (Act C3). The handy terminal 30 displays the content that is distributed from the content distribution system 21. As described above, the content that is displayed on the handy terminal 30 is synchronized with the tablet terminal 33 that is used by the customer who is a serving target.

In addition, if information effective for extraction of a product that is desired by the customer can be obtained through conversation with the customer during customer serving, the customer serving attendant 49-2 can input the information from the handy terminal 30 as attendant information (additional information). Examples of the additional information include various pieces of information such as a product category (priority designation) of a product that is desired by the customer, a color and a shape which are favored by the customer, and a using object of the product. In this embodiment, for example, the customer serving attendant 49-2 inputs a text indicating the additional information to the handy terminal 30 through operation of a software keyboard and the like. An input formation of the addition information is not limited to the text, and may be other formats such as a voice, an image, and selection from a menu that is prepared in advance.

In addition, the customer serving attendant 49-2 can designate priority with respect to the additional information. The priority is information that is used to adjust ease of extraction of a product that corresponds to the additional information (keyword) during extraction of a product to be recommended to a customer. For example, an arbitrary value can be designated in a range (for example, 0 to 100) that is determined in advance. For example, if information obtained during conversation with a customer relates details which are strongly desired by the customer, the customer serving attendant 49-2 designates priority to be high. According to this, it is easy for a product corresponding to the additional information to be extracted as a recommendation target to the customer. In addition, if the information obtained during conversation with the customer does not relate to the details which are strongly desired by the customer, the customer serving attendant 49-2 designates the priority to be low. If additional information with low priority is input, the product that directly corresponds to the additional information is not extracted as a recommendation target to the customer. However, as will be described later, when a plurality of pieces of additional information are repetitively input, although the priority of respective pieces of additional information is low, a customer's favorite product tends to be extracted.

When the customer information (additional information) is input by operation of the customer serving attendant 49-2 (Yes in Act C5 and Act C6), the handy terminal 30 extracts keyword candidates with respect to the additional information (text data), for example, by using a method such as a morpheme analysis. The handy terminal 30 displays the keyword candidates, and allows the customer serving attendant 49-2 to select a keyword to be transmitted to the content distribution system 21. The customer serving attendant 49-2 may select all of the keyword candidates or may select an arbitrary keyword. in addition, the handy terminal 30 inputs priority with respect to a keyword that is selected by the customer serving attendant 49-2 through operation of the customer serving attendant 49-2. When the keyword and the priority are input, the handy terminal 30 transmits the keyword and the priority to the content distribution system 21, and notifies the content distribution system 21 of a request for extraction of content.

When receiving the additional information (the keyword and the priority) from the handy terminal 30, the content distribution system 21 reflects the additional information on the customer information 81, the customer attribute cluster 82, and the product cluster 83, and extracts a product (product cluster) (Act C7).

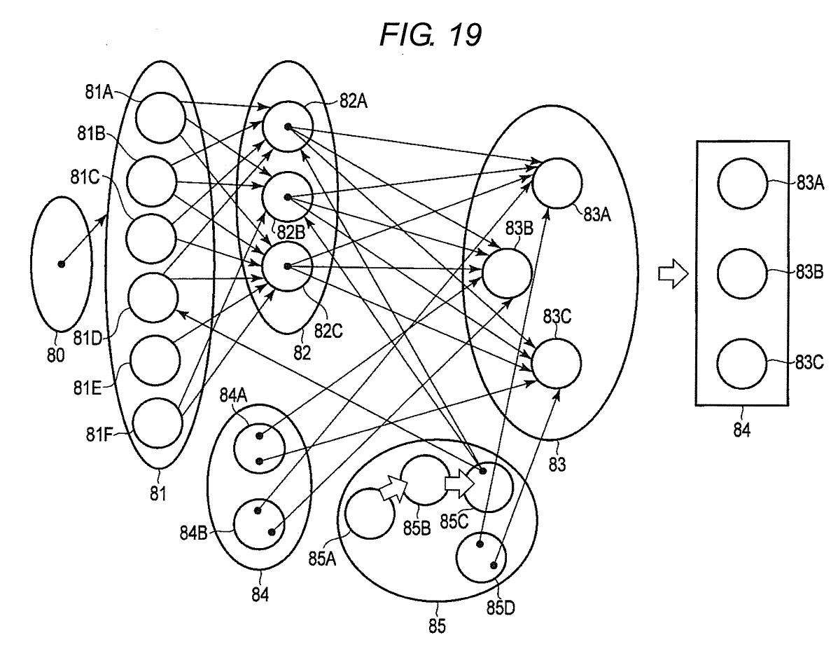

FIG. 19 is a diagram illustrating extraction of content for a customer which is performed by the content distribution system 21 in this embodiment. As illustrated in FIG. 19, the attendant information 85 includes a keyword candidate 85B that is extracted from the additional information (text 85A) that is input from the customer serving attendant 49-2, and a keyword 85C that is selected from keyword candidates 85B. In an example illustrated in FIG. 19, the keyword 85C is reflected on the customer information 81 and the behavior cluster 82C. In addition, if a product category (priority designation 85D) of a product that is desired by a customer is input as the additional information, the product category is reflected on a corresponding product cluster of the product cluster 83. In the example illustrated in FIG. 19, the product category is reflected on product clusters 83A and 83C in accordance with the priority designation 85D.

In addition, a process of extracting the product cluster in correspondence with a customer is executed in the same manner as the description with reference to FIG. 12, and thus detailed description thereof will not be repeated. However, the information that is added as the attendant information 85 is reflected, and thus it is easy to extract the product cluster relating to the attendant information 85. For example, with respect to an attribute corresponding to a keyword included in the customer attribute cluster 82, or a product corresponding to a keyword included in the product cluster 83, the content distribution system 21 carries out weighting in accordance with priority that is designated with the keyword, and calculates intensity between clusters. Accordingly, intensity that is calculated with respect to information or a cluster which relates to the attendant information (additional information) increases, and thus it is easy to extract a corresponding product cluster.

The content distribution system 21 creates content (product catalog) with respect to a product corresponding to the extracted product cluster as recommendation information for each customer (Act C8), and distributes the content to the handy terminal 30 (Act C9). The handy terminal 30 displays the content that is received from the content distribution system 21 (Act C10). Here, the customer serving attendant 49-2 confirms content that is changed by addition of the attendant information, and gives an instruction of content distribution to the tablet terminal 33 that is used by a customer. In accordance with the instruction of content distribution which is transmitted from the customer serving attendant 49-2, the tablet terminal 33 notifies the content distribution system 21 of the request for distribution of content (Act C11). In response to the request for distribution of content which is transmitted from the handy terminal 30, the content distribution system 21 extracts content for a customer which corresponds to the content (product) distributed to the handy terminal 30 (Act C12), and distributes the extracted content to the tablet terminal 33 (Act C13). The tablet terminal 33 displays content which is distributed from the content distribution system 21 and on which the attendant information 85 is reflected.

In addition, the customer serving attendant 49-2 also inputs the attendant information (additional information) during business negotiation with a customer to change content that is distributed to the handy terminal 30 and the tablet terminal 33 as described above. Accordingly, when repetitively inputting the information obtained from a customer, it is possible to extract a customer's favorite product and to provide the product to the customer. According to this, it is becomes easy for the customer serving attendant 49-2 to proceed the business negotiation. In addition, the customer can easily select a desired product among a plurality of products.

In addition, in the above description, the description is given of an example in which the customer serving attendant 49-2 inputs the attendant information 85, but another store staff may input the attendant information 85.

For example, the reception attendant 49-1 inputs, for example, a store visiting purpose, which is obtained from a customer who visits a room, to the reception terminal 25. The reception terminal 25 transmits the information relating to the store visiting purpose to the content distribution system 21 as the attendant information 85. For example, the reception terminal 25 transmits information such as “purchase of a product for a child for congratulation of admission to a school” to the content distribution system 21 as the store visiting purpose. The content distribution system 21 adds the information relating to the store visiting purpose to the customer information 81, and makes intensity of information corresponding to the customer attribute cluster 82 or the product cluster 83 increase on the basis of the information “purchase of a product for a child for congratulation of admission to a school”.

In FIG. 19, as the customer information 81, a store visiting history 81C, a store visiting purpose 81D, a browsing history 81E, and additional attendant information 81F are illustrated in addition to the information 81A during registration and the purchase history 81B.

In addition, a content providing attendant 49-6 can reflect store policy information that is frequently changed on the extraction of the product cluster. Examples of the store policy information include a sales-strategy product for which the number of sales is desired to be increased on a store side, a product for members only which is prepared by a store for members, and the like.

In an example illustrated in FIG. 19, as the store policy information 84, a sales-strategy product 84A, and a product for members only 84B are illustrated. In this case, with respect to product clusters which correspond to the sales-strategy product 84A and the product for members only 84B, the content distribution system 21 calculates intensity in order for the intensity with other clusters to be raised. According to this, a product cluster, which corresponds to the store policy information 84, tends to be extracted.

In this manner, when the store staff adds the information through the staff terminal 14, it is possible to provide content with respect to a product, on which the information is reflected, to a customer. Accordingly, it is possible to appropriately provide information relating to a customer's favorite product.

Next, description will be given of a case where content is changed on the basis of information that is added by a customer. For example, when the customer is in the waiting space 44 or on the table seat 46 or the table terminal 32, the customer is allowed to input information relating to a favorite product while viewing content that is distributed from the content distribution system 21, and content relating to a recommendation product that is extracted, or content of another product is configured to be distributed from the content distribution system 21.

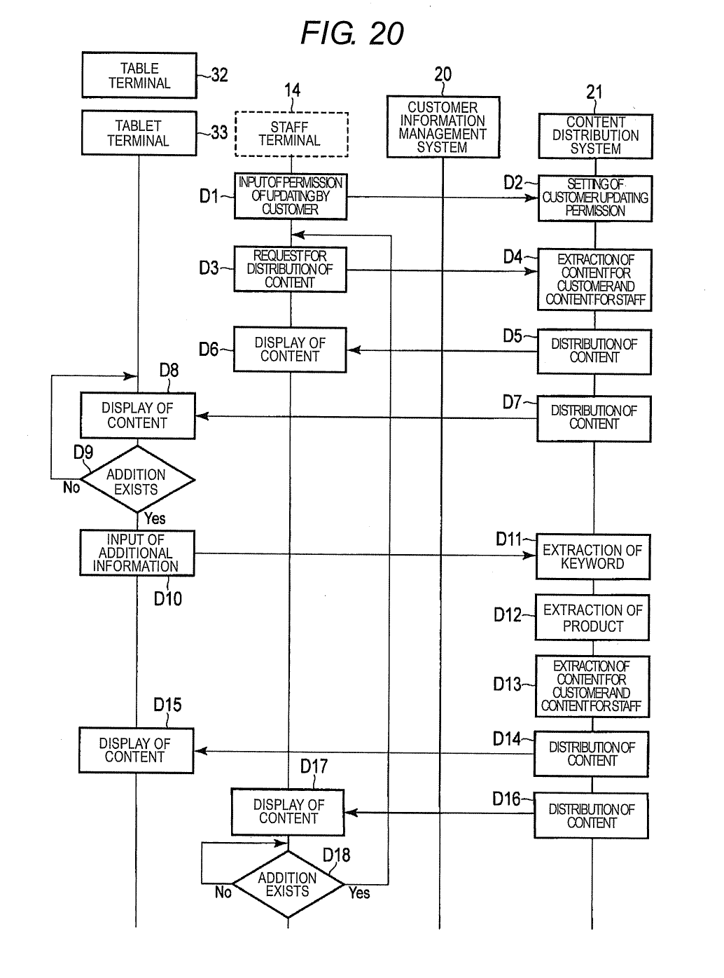

Here, description will be given of a process of changing content (recommendation information) on the basis of information that is input from the tablet terminal 33 (table terminal 32) with reference to a flowchart illustrated in FIG. 20.

When updating of content by a customer in accordance with additional information is permitted, a store staff (for example, the customer serving attendant 49-2) inputs an instruction of permission of updating by a customer from the staff terminal 14 (for example, the handy terminal 30) (Act D1). The handy terminal 30 notifies the content distribution system 21 of the permission of updating by a customer. The content distribution system 21 sets the permission of updating by a customer with respect to the customer serving device 16 (for example, the tablet terminal 33) which corresponds to the handy terminal 30 that is notified of the permission of updating by a customer (Act D2).

The handy terminal 30 transmits a request for distribution of content to the content distribution system 21 in response to the instruction from the customer serving attendant 49-2 (Act D3). In response to the request for distribution of content, the content distribution system 21 extracts content for a customer (member) who browses content and content for a store staff (customer serving attendant 49-2) (Act D4). The content distribution system 21 distributes the extracted content for a staff to the handy terminal 30 (Act D5). The handy terminal 30 displays the content that is distributed from the content distribution system 21 (Act D6). In addition, the content distribution system 21 distributes the content for a customer to the tablet terminal 33 (Act D7). The tablet terminal 33 displays the content that is distributed from the content distribution system 21. When distributing content to the tablet terminal 33 to which the permission of updating by a customer is set, the content distribution system allows the tablet terminal 33 to input additional information that is used for narrowing-down of a product.

Here, when browsing content that is displayed on the tablet terminal 33 and extracting a desired product, a customer inputs additional information, which is used to extract a product, as a request for addition by a customer by using the table terminal 32 (Act D9 and Act D10). The tablet terminal 33 transmits additional information that is input by a customer to the content distribution system 21 (Act D11). The content distribution system 21 extracts a keyword as a request 86 for addition by a customer from additional information (Act D11). In addition, a customer can designate priority with respect to the additional information.

Examples of the additional information include text data or an image which is transmitted from a portable terminal that is carried by a customer, text data that is input to the tablet terminal 33 through a software keyboard or handwriting, an image captured by a camera provided to the tablet terminal 33, a voice that is input by a customer through a microphone of the tablet terminal 33, and text data obtained through voice recognition with respect to the voice that is input. With regard to the text data, for example, a keyword candidate is extracted through a morpheme analysis and the like similar to the input of the above-described attendant information 85. In addition, with regard to the image, a keyword candidate, which is registered in correspondence with an analogous image, can be extracted by searching the analogous image from images which are recorded in an image database in advance, or a property (an analogous image property) of the analogous image can be extracted by searching the analogous image through the Internet. Examples of the analogous image property include a keyword candidate that is extracted from a text of a title, a body text, and the like which relate to the analogous image, and the like.

In addition, in the above description, the keyword is extracted from the additional information in the content distribution system 21. However, a keyword may be extracted from the additional information in the tablet terminal 33, and may be transmitted to the content distribution system 21.

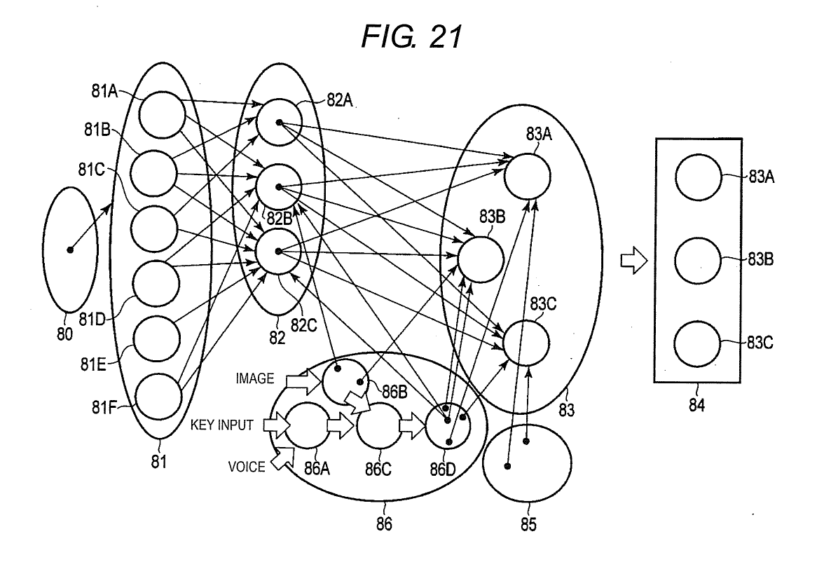

FIG. 21 is a diagram illustrating extraction of content for a customer which is carried out by the content distribution system 21 in this embodiment. As illustrated in FIG. 21, the request 86 for addition by a customer includes a keyword candidate 860 extracted from a text 86A that is input through key input or voice recognition, and a keyword 86D that is extracted from a keyword candidate 86C. In addition, the keyword candidate 85C includes a keyword that is extracted from an analogous image property 86D obtained on the basis of an image that is input by a customer. In addition, reflection of the request 86 for addition by a customer (keyword) on the customer information 81, the customer attribute cluster 82, and the product cluster 83 is executed in the same manner as in the description with reference to FIG. 19, and thus description thereof will not be repeated.

The content distribution system 21 reflects the request 86 for addition by a customer on the customer information 81, the customer attribute cluster 82, and the product cluster 83, and extracts a product (product cluster) (Act D12). In addition, if priority is designated to additional information, the content distribution system 21 extracts the product cluster after reflection of the priority. The content distribution system 21 extracts content for a customer (member) who browses content and content for a store staff (customer serving attendant 49-2) in accordance with the product cluster that is extracted (Act D13). The content distribution system 21 distributes the extracted content for a customer to the tablet terminal 33 (Act D14). The tablet terminal 33 displays the content that is distributed from the content distribution system 21 (Act D15). The content that is displayed on the tablet terminal 33 is configured of content that is extracted for a product on which the information added by a customer is reflected.

In addition, the content distribution system 21 distributes the content for the store staff to the handy terminal 30 (Act D16). The handy terminal 30 displays the content that is distributed from the content distribution system 21 (Act D17). The customer serving attendant 49-2 can browse the content that is displayed on the handy terminal 30, can add the attendant information 85 as described above, and can extract a product to be recommended to a customer (Act D18).

As described above, the customer service system 10 in this embodiment can extract a product to be recommended to a customer by using the information that is input from the staff terminal 14 that is used by a store staff, and the information that is input from the customer serving device 16 that is used by a customer. In addition, contents for the same product are respectively displayed on the staff terminal 14 and the customer serving device 16 in synchronization manner, and thus the contents can be set as details for a customer and details for a store staff. That is, content for easy confirmation of a product is displayed on the customer serving device 16, and content including information (supplementary information and the like) effective for customer serving is displayed on the staff terminal 14. Accordingly, communication between the customer and the store staff become easy through the customer service system 10, and thus sales-promotion of a product can be expected.

In addition, the above description is made on the assumption that the content providing system (customer service system 10) in this embodiment is used in the business negotiation room for the exclusive use of members, but there is no limitation thereto. For example, it is not necessary for all of the systems 20 to 23, the terminals 25 to 27, the handy terminal 30, the table terminal 32, the tablet terminals 33, and the like in FIG. 1 to be disposed at the same location such as the business negotiation room. For example, it is possible to construct the content providing system (customer service system 10) by connecting the systems or terminals to each other through a network such as the Internet through which wide area communication is possible.

In addition, the above description is made on the assumption that one store staff serves one customer by using the customer service system 10. However, for example, the customer service system 10 can be used for a case where a plurality of store staffs serve one customer. For example, two store staffs can input new attendant information 85 by individually using the handy terminals 30-1 and 30-2. In this case, contents which are distributed to the handy terminals 30-1 and 30-2 from the content distribution system 21 may be the same content based on a product that is extracted by inputting the attendant information 85, or may be contents with different details. Similarly, a plurality of customers can input new request 86 for addition by a customer by individually using a plurality of the table terminals 32 or the tablet terminals 33. However, in this case, the content distribution system 21 extracts the product cluster on the basis of customer information of any one person to create content (product catalog). In addition, the content distribution system 21 may distribute the same content to the table terminals 32 or the tablet terminals 33 which are used by a plurality of customers, or may distribute different contents thereto.

In addition, the content providing system in this embodiment can be realized not only as the customer service system 10 but also as another system that provides information (content) on a product to a customer and the like.

In addition, the invention is not limited to the above-described embodiment, and may be implemented by modifying constituent elements in a range not departing from the gist in an execution stage. In addition, various inventions may be realized by appropriate combination of a plurality of constituent elements disclosed in the above-described embodiment. For example, several constituent elements may be omitted from the entire constituent elements illustrated in the embodiment. In addition, constituent elements according to another embodiment can be appropriately combined.

In addition, the processes described in the above-described embodiment can be provided to various apparatus as a program that can be executed by a computer, for example, after being recorded on a recording medium such as a magnetic disk (a flexible disk, hard disk, and the like), optical disc (a CD-ROM, a DVD, and the like), and a semiconductor memory. In addition, the processes can be provided to various apparatus through transmission by using a communication medium. The computer reads out the program that is recorded on the recording medium, receives the program through the communication medium, and operation thereof is controlled by the program to execute the above-described processes.

What is claimed is:

1. A content providing system in which a first electronic apparatus that is used by a customer, and a second electronic apparatus that is used by a store staff are connected to a server that provides a plurality of pieces of product-related information,
wherein the server includes,
a product extraction unit that extracts a specific product, whose information is provided to the customer, among the plurality of products on the basis of customer information that is registered with respect to the customer, first information that is input from the first electronic apparatus, and second information that is input from the second electronic apparatus, and
a distribution unit that distributes a first content relating to the specific product to the first electronic apparatus, and distributes a second content different from the first content relating to the specific product to the second electronic apparatus.

2. A server, comprising:
a product extraction unit that extracts a specific product, whose information is provided to a customer, among a plurality of products on the basis of customer information that is registered with respect to the customer, first information that is input from a first electronic apparatus, and second information that is input from a second electronic apparatus; and
a distribution unit which distributes a first content relating to the specific product to the first electronic apparatus, and distributes a second content different from the first content relating to the specific product to the second electronic apparatus.

3. A server, comprising:
a product extraction unit that extracts a specific product, whose information is provided to a customer, among a plurality of products on the basis of customer information that is registered with respect to the customer;
a first changing unit that changes the specific product on the basis of first information that is input from a first electronic apparatus that is used by the customer;
a second changing unit that changes the specific product on the basis of second information that is input from a second electronic apparatus that is used by a store staff; and
a distribution unit which distributes a first content relating to the specific product to the first electronic apparatus, and distributes a second content that is different from the first content relating to the specific product to the second electronic apparatus.

4. The server according to claim 3,
wherein if a priority is designated to the first information, the first changing unit changes the specific product in accordance with the priority, and
if a priority is designated to the second information, the second changing unit changes the specific product in accordance with the priority.

5. The server according to claim 3,
wherein the first changing unit changes the specific product by repetitively inputting the first information, and
the second changing unit changes the specific product by repetitively inputting the second information.

6. A program allowing a computer to function as:
a product extraction unit that extracts a specific product, whose information is provided to a customer, among a plurality of products on the basis of customer information that is registered with respect to the customer, first information that is input from a first electronic apparatus, and second information that is input from a second electronic apparatus; and
a distribution unit which distributes a first content relating to the specific product to the first electronic apparatus, and distributes a second content different from the first content relating to the specific product to the second electronic apparatus.
